(19) United States
(12) Patent Application Publication
(10) Pub. No.: US 2022/0074005 A1
(43) Pub. Date: Mar. 10, 2022

(54) BREATHABLE LAMINATED LEATHER

(71) Applicant: ECCO Sko A/S, Bredebro (DK)

(72) Inventor: Panagiotis Mytaros, Bredebro (DK)

(21) Appl. No.: 17/416,656

(22) PCT Filed: Dec. 19, 2019
(86) PCT No.: PCT/DK2019/050414

§ 371 Date: Jun. 21, 2021

(30) Foreign Application Priority Data
Dec. 21, 2018 (DK) PA 2018 70859

(51) Int. Cl. C14B 7/04; B32B 7/12; B32B 9/02; B32B 9/04; B32B 7/022

(52) U.S. Cl. CPC C14B 7/04; B32B 7/12; B32B 9/025; B32B 9/047; B32B 7/022; B32B 2250/02; B32B 2307/5825; B32B 2307/732; B32B 2437/00; B32B 2307/724; B32B 2307/748; B32B 2307/54

(57) ABSTRACT

A leather laminate composite includes a leather layer and reinforcing fabric laminated together via an adhesive. The adhesive includes water vapor passages.

### FIELD OF THE INVENTION

This invention relates to a breathable laminated leather.

### BACKGROUND OF THE INVENTION

Leather is a well-known material for several products and product types. Such leather product include e.g. footwear, accessories, furniture, clothing, etc.

A challenge in relation to leather is for many applications that the strength properties introduces un-wanted stretch of the leather item in which the leather is applied. This is of course more critical in some applications than others.

In some applications it is possible to e.g. increase the thickness of the leather or attach the leather to a kind of reinforcement by means of adhesive or stitching.

Both methods are to some critical applications of less use as either the thickness of the reinforced leather becomes significant and becomes difficult to use. The alternative method of reinforcing the leather also invokes compromises where the end-product looses the benefits usually desired in relation to leather products or products comprising leather

### SUMMARY OF THE INVENTION

The invention relates to a leather laminate comprising a leather layer (11) and reinforcing fabric (13) laminated together by means of an adhesive (10; 20; 30), wherein the adhesive comprises water vapor passages (14, 15; 21, 22; 31, 32).

It should be noted that the present laminate is characterized by these three important layers and furthermore by introduced adhesive free passages. The adhesive-free passages facilitate direct transmission of water vapor through the adhesive between the leather layer and the reinforcing fabric. It is overall important to match the applied adhesive free passages with the water vapor permeability of the applied leather layer and the reinforcing fabric to obtain the desired overall water vapor permeability.

By the application of water vapor passages, it is possible to obtain a leather composite with a breathability where the variation in the breathability, especially when measured across the individual leather hides used as a leather source is decreased. The breathability may thus be much more predictable according to the provisions of the invention.

In an embodiment of the invention, the leather laminate has a water vapor permeability of above 5 mg/cm2/hour, such as above 8 mg/cm2/hour, such as above 10 mg/cm2/hour.

Breathability and water vapor permeability are used interchangeably and may be evaluated by suitable methods for determining water vapor permeability of leather. Standard methods such as SATRA TM 172 may be used to test the water vapor permeability. Briefly, the measurement may be of a test piece of material fixed over the opening of a jar. Mass of the moisture passing through the test piece in the jar is weighted and water vapor permeability can be calculated.

In an embodiment of the invention, the leather laminate has a water vapor permeability of above 5 mg/cm2/hour, such as above 8 mg/cm2/hour, such as above 10 mg/cm2/hour and wherein the breathability is measured according to SATRA TM 172.

In an embodiment of the invention, the variation of breathability of a leather laminate varies with less than 25% measured over plurality of leather laminates.

A plurality of leather laminates may e.g. refer to 100 leather laminates based on 100 cow leather hides and wherein the variation is measured relative over all the 100 laminates but referring to the same region of the hides used for the respective leather laminates.

In an embodiment of the invention, the thickness of the reinforcing fabric is below 0.1 mm.

In an embodiment of the invention the ultimate tensile strength of the reinforcing fabric is at least above 5 kN/m, such as at least above 10 kN/m or such as at least above 15 kN/m.

In an embodiment of the invention the elongation at break of the reinforcing fabric is less than 5%, such as less than 4%, or such as less than 3%.

In an embodiment of the invention the elongation at break of the reinforcing fabric is between 0.2% and 10%, such as between 2% and 8% such as between 3% and 6%

A relatively low elongation at break, combined with the high strength of the reinforcing fabric and the laminate, make it possible, even when applying a partly covering adhesive comprising vapor passages, to provide an attractive leather laminate which may be used even if the thickness of the leather layer has been reduced to a previously not obtainable low thickness. It should be noted that the leather of the laminate would risk undesired modification or breaks in the surface of the leather when reducing the thickness, e.g. in a laminate comprising a fabric possessing relatively high flexibility or low strength,

In an embodiment of the invention the tear strength of the reinforcing fabric is at least 25 N, such as at least 50 N, or such as at least 75 N.

In an embodiment of the invention the tensile strength of the reinforcing fabric is at least above 1 GPa, such as at least above 1.5 GPa, such as at least 2 GPa, such as at least 2.5 GPa, such as at least 3 GPa.

In an embodiment of the invention the tensile strength of the reinforcing fabric is between 1 GPa and 5 GPa, such as between 2.5 GPa and 4 GPa.

The application of an extremely high strength reinforcing fabric according to the above provisions of embodiments of the invention makes it possible to ensure that the surface of the leather of the leather laminate is durable and resistant to wear in use, in particular when the leather surface of the leather laminate is formed by the top-grain side.

It should generally be noted that tensile strength of the reinforcing fabric of the laminate, unless otherwise noted, is generally referred to the reinforcing fabric alone and not referring to the strength when laminated.

In an embodiment of the invention the peel strength of the leather laminate is at least 0.3 N/mm, such as at least 0.4 N/mm, such as at least 0.5 N/mm and wherein the peel strength is measured according to SATRA TM 401 with a SATRA STM 566 Tensile testing machine.

In an embodiment of the invention the peel strength of the leather laminate is between 0.3 N/mm and 1.5 N/mm, such as between 0.4 N/mm and 0.8 N/mm, such as between 0.4 N/mm and 0.6 N/mm and wherein the peel strength is measured according to SATRA TM 401 with a SATRA STM 566 Tensile testing machine.

Unless otherwise mentioned, a SATRA STM 566 Tensile testing machine is applied for the peel strength test and the measurement is carried out according to the test method SATRA TM 401. The tested laminate samples have a length of 100 mm and a width of 30 mm. The laminate is separated or split in half of the length of the sample, i.e. up to about 50 mm, while ensuring with a manual slight pull that the leather and reinforcing fabric is fully separated at the last part of the partially separated laminate parts around the half-length. The laminate is then coupled to the above-mentioned testing machine in the separated end of the sample, e.g. the reinforcing fabric, and then fixed to a stationery part at the non-separated part of the sample and the separation force required to split the laminate further is measured in N (Newton)

It is noted that the obtainable peel strength is much better than expected even when applying adhesive according to the provisions of the invention. The high peel strength thus expresses that the leather of the laminate, even under stress is strongly fixated to the laminate, thereby benefitting from the properties of the reinforcing fabric.

It should be noted that other ways of measuring peel strength highlighting different characteristics of the laminate may of course be applied within the scope of th invention. In the present context it is however believed that the applied method expresses a representative and reproducible measurement method.

In an embodiment of the invention the reinforcing fabric, the adhesive and the leather are compatible.

Compatibility in the present context means that the applied adhesive must be adapted for interact with each other to establish a durable bonding between the leather and the reinforcing fabric.

In an embodiment of the invention the leather is obtained from top grain leather.

In an embodiment of the invention the flesh-side of the leather layer (11) is facing the reinforcing fabric (13) of the laminate composite.

In an embodiment of the invention, the leather is tanned and extends in a X and Y direction.

In an embodiment of the invention, the leather laminate has a thickness of 0.4 to 0.6 mm.

In an embodiment of the invention, the leather laminate has a thickness of above 0.6 to 1.2 mm.

In an embodiment of the invention, the leather laminate has a thickness of above 1.2 to 2 mm.

In an embodiment of the invention, the leather laminate has a thickness of above 2.0 to 3 mm.

In an embodiment of the invention, the reinforcing fabric of the leather laminate has a thickness of below 0.1 mm.

The thickness of the leather laminate may e.g. be measured by a SATRE STD 483. In an embodiment of the invention, the leather of the leather laminate is originating from a cow hide and wherein the leather is tanned.

In an embodiment of the invention, the leather of the leather laminate comprises tanning agents in the amount of 3 to 15% by weight of the leather.

In an embodiment of the invention, the leather of the leather laminate comprises tanning agents in the amount of 7 to 15% by weight of the leather and wherein the tanning agents are vegetable tanning agents.

In an embodiment of the invention, the vegetable tanning agents are obtained from chestnut wood, quebracho wood, tara pods, catechu, chinese gallnut, turkish gallnut, gambier, myrobalan, oakwook, sumac, bark from yate and/or valonia oak.

In an embodiment of the invention, the leather of the leather laminate comprises tanning agents in the amount of 3 to 12% by weight of the leather and wherein the tanning agents includes chrome tanning agents.

In an embodiment of the invention, the chrome tanning agents includes chromium, chromium salts and/or derivatives thereof.

In an embodiment of the invention, the leather of the leather laminate comprises chrome tanning agent(s) in the amount of 1 to 7% by weight of the leather, such as 2 to 6% by weight of the leather such as 2 to 5% by weight of the leather.

The specific content of chrome tanning in the amount of 1 to 7% by weight of the leather, such as 2 to 5% by weight of the leather is in particular attractive in relation to the inventive leather laminate as this content of chrome in the leather of the laminate makes is possible to use heat-activated adhesive to attach the leather to the reinforcing fabric. It is moreover, and even more advantageous in applications where the leather has to be steamed e.g. for purposes of shaping etc.

In an embodiment of the invention, the chrome tanning agents includes chromium, chromium salts and/or derivatives thereof.

A composite in the present context is preferably comprising high strength fibers.

### THE FIGURES

The invention will be described in the following with reference to the drawings where,

FIG. 1A illustrates components of a leather laminate within the scope of the invention

FIG. 1B illustrates a cross-section of the laminate of FIG. 1A,

FIG. 2 illustrates a structure of an adhesive of a leather laminate within the scope of the invention,

FIG. 3 illustrates a structure of an adhesive of a further leather laminate within the scope of the invention and where

FIG. 4 illustrates a structure of an adhesive of a further leather laminate within the scope of the invention.

### DETAILED DESCRIPTION

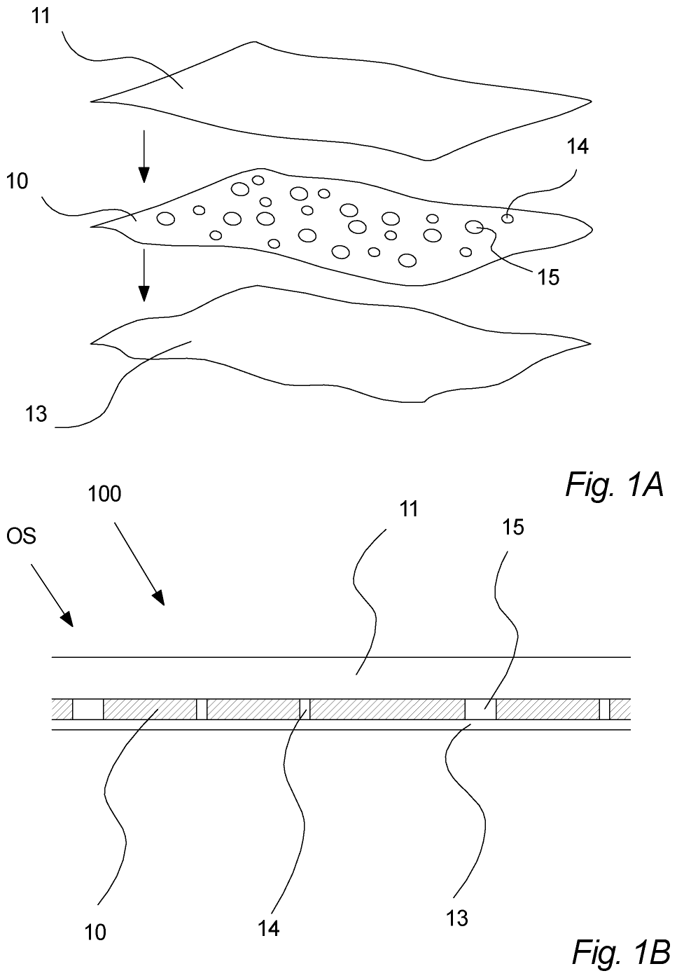

FIG. 1B illustrates a cross-section of a leather laminate made according to the provisions of the invention.

The illustrated leather laminate 100 comprises a leather layer 11 bonded to a reinforcing fabric 13 by means of an adhesive 10. The outer surface, when applied in a footwear, is shown with arrow OS.

It should be noted that the present laminate is characterized by these three important layers and furthermore by introduced adhesive free water vapor passages 14 and 15. The adhesive-free passages facilitates direct transmission of water vapor through the adhesive between the leather layer 11 and the reinforcing fabric 13. It is overall important to match the applied adhesive-free water vapor passages 14 and 15 with the water vapor permeability of the applied leather layer 11 and the reinforcing fabric 13 to obtain the desired overall water vapor permeability.

According to a preferred embodiment of the invention, the leather laminate 100 should be designed to have a high water vapor permeability, of above 5 mg/cm2/hour.

Thus, the reinforcing fabric 13 is characterized by strength along the X and Y-directions of the leather layer to which it is bonded. The reinforcing fabric 13 has a strength which is substantially higher than the leather of the leather layer 11 in the direction of the layers. The reinforcing fabric may possess different properties in terms of water vapor permeability (WVP) is the measurement of the time rate of water vapor transmission through unit area of flat material of unit thickness induced by unit vapor pressure difference between two specific surfaces, under specified temperature and humidity conditions.

In case of a sports shoe or the like, water vapor permeability should e.g. be above 5 mg/cm2/hour. In such case, a water vapor permeability of all three layers, or at least the two layers, the reinforcing fabric 13 and the adhesive should together facilitate an overall acceptable water vapor permeability. Reinforcing fabrics having high water vapor permeability are known within the art. Care should however be taken when applying adhesive between the two layers, the reinforcing fabric 13 and the leather layer 11 as the resulting matrix of adhesive between the layer 13 and 11 should not effectively seal the laminate. This may e.g. be avoided when applying adhesive in an adhesive pattern with the adhesive-free passages, i.e. physical passages free of adhesive and forming a passage for transmission of vapor. In other words, in such a situation, it is advantageous to have contacting areas between the layers 11 and 13 where there is no adhesive blocking optional vapor transmission.

The adhesive applied within the scope of the invention must ensure a safe and reliable bonding or adhesion between the leather layer and the reinforcing fabric thereby ensuring the complete laminate has the overall desired strength.

The adhesive can in principle be any adhesive capable of bonding leather and the reinforcing fabric at the same time. Different aspects of such an adhesive and the method of applying it will be discussed below. The specific use will give directions to the used adhesive and lamination method.

Typically, the adhesive is used in combination with a hardener to aid in the bonding. Suitable levels of hardener are up to 20%, more typically up to 10%, for instance 95% adhesive, 5% hardener.

Specific adhesives and hardeners that have been used in combination include Helmitin® DS/17, available from Helmitin Adhesives, together with Swift Hardener 9538 Blue. This combination can be applied by spraying on to the leather.

As leather is absorbent, the adhesive typically soaks into the leather after it has been applied which provides a stronger bond.

The adhesive is applied at a suitable level to ensure the reinforcing fabric forms a strong bond to the leather. Typical levels if applying by spray are around 15 to 60 g/m2, e.g. around 20-40 g/m2. However, these levels are dependent on the concentration of the adhesive in the solution. It would nevertheless be within the ability of the skilled person to adjust the level of adhesive accordingly to achieve the desired bonding strength to avoid delamination during use.

The laminating step typically comprises the following steps:
applying an adhesive on the first side of the piece of leather; and
contacting a reinforcing fabric with the adhesive.

The applying step may be by any means, including spraying, brushing or with rollers. However, spray adhesives can lead to clogging of the spray gun nozzle, and so typically the adhesive is applied by a roller-coater in commercial production.

The adhesive layer on the leather can be contacted with the reinforcing fabric immediately after application. However, typically bonding is better if the adhesive is allowed some time to soak into the leather, for example a soaking step of from 5 seconds to 1 hour, more typically 1 minute to 45 minutes, e.g. 5 minutes to 30 minutes.

The adhesive can also benefit from such a curing step as it can partially dry, improving its tackiness and capability to bond to the reinforcing fabric. However, if the delay between applying the adhesive and contacting the reinforcing fabric is too long, the adhesive may no longer be capable of forming a strong bond with the reinforcing fabric. Consequently, it is desirable to contact the reinforcing fabric while the adhesive retains some tackiness.

In order maintain a successful bond throughout the remaining processes the adhesive may require heat and/or force to aid in bonding the leather and reinforcing fabric.

Therefore, the method optionally includes a bonding step after the reinforcing fabric is contacted with the adhesive.

As an example, bonding is achieved by passing the laminate through a roller (e.g. a rotopress), such as a heated roller. So as not to damage the second side of the leather, suitably at least of the rollers is compressible, such as a felt roller, a rubber roller, a foam roller or the like.

If the laminate is heated, the temperature should not be too high or else the reinforcing material may become structurally compromised or the leather may discolor. Suitable maximum temperatures are 25° C. below the melting point of the high strength fiber or 115° C., whichever is lower.

If the high strength fibers can tolerate higher temperatures, it may be possible to form the laminate with a hot melt adhesive from a multilayer structure comprising the reinforcing fabric, hot melt adhesive and leather, such that heat and pressure are applied to allow the adhesive to melt and flow forming the bond between the reinforcing fabric and leather. Such a hot melt adhesive could be included in the laminate by any means, including as part of the reinforcing fabric, as a separate layer, or applied to the leather. However, if forming the leather laminate in this way, care must be taken not to expose the leather to overly high temperatures particularly for extended periods, in case the leather becomes discolored.

Possible processing steps in the lamination step/adhesion step of the method therefore include:
applying an adhesive to the first side of the piece of leather, for example as a spray;
optionally allowing the adhesive to soak into the leather, for example in a curing step of from 1 to 30 minutes;
contacting a reinforcing fabric with the adhesive to form a multilayer structure comprising a layer of the reinforcing fabric, a layer of the adhesive and the leather;
optionally applying heat and/or pressure to the multilayer structure, for example by passing the multilayer structure through the nip of a heated roller; and
optionally allowing the adhesive to dry, for example in a drying step of at least 8 hours.

The multilayer structure preferably comprises the reinforcing fabric in contact with the adhesive, with said adhesive also being in contact with the first side of the leather (i.e. there are not intervening layers between the reinforcing fabric and the adhesive or the adhesive and the first side of the leather).

The lamination step may optionally be succeeded by a milling process of the laminate. The milling should only be carried out once the adhesive has fully dried and properly bonded to the reinforcing fabric. Consequently, there is typically a drying step of at least 10 minutes prior to roll milling, more typically at least 1 hour, more typically at least 4 hours, e.g. at least 8 hours. Often, the laminates are left overnight to ensure the adhesive is fully dried prior to milling.

The milling of the finished laminate may at the same time provide very attractive leather appearance of the top-grain facing away from the reinforcing fabric with a very special texture and also provided softness to the leather laminate without compromising the footwear application.

The reinforcing fabric 13 provides strength to the laminate, allowing the leather layer to be thin and the overall laminate to be flexible. The reinforcing fabric is therefore relatively thin and has high tensile strength, high tear strength and low elongation at break.

Suitably, the basis weight for the reinforcing fabric is below 150 g/m2, typically below 100 g/m2, more typically below 75 g/m2, and most typically below 60 g/m2.

A suitable method for measuring the basis weight of the reinforcing fabric is ASTM D3776.

Suitably, the ultimate tensile strength (breaking strength) of the reinforcing fabric is above 5 kN/m, more typically above 10 kN/m, or even above 15 kN/m.

The ultimate tensile strength expressed in kN/m is the pulling force required to break a 1 m wide sample of the material. A suitable test for measuring the ultimate tensile strength of the reinforcing fabric is ISO 3376: 2011. An alternative test specifically adapted for testing tensile properties of polymer matrix composites which could be used is ASTM D3039.

Examples of commercially available reinforcing fabrics from Dyneema applicable for use in embodiments of the present invention have tensile strengths of between 3 GPa and 4 GPa, such as 3.5 GPa. Other manufacturers may offer applicable reinforcement fabrics having tensile strengths of between 2.5 GPa and 3.5 GPa

Suitably, the elongation at break of the reinforcing material (i.e. the elongation of the fabric when stretched to its breaking point) is less than 5%, typically less than 4%, or even less than 3%.

A suitable test for measuring the elongation at break is ISO3376:2011. An alternative test specifically adapted for testing the elongation properties of polymer matrix composites which could be used is ASTM D3039.

Suitably, the tear strength of the reinforcing material is above 25 N, typically above 50 N, or even above 75 N.

A suitable method for measuring the tear strength of the reinforcing material is ISO 3377-1:2011. An alternative test specifically adapted for testing the tear strength of polymer matrix composites which could be used is Mil-C-21189 10.2.4.

It will be clear from the above characteristics that the reinforcing fabric is very low basis weight (and hence typically very thin) yet typically has very high tensile strength and tear strength. Suitable materials that fulfil these requirements include fabrics which include at least one layer comprising high strength fibres.

By “high strength fibre” is meant a fibre having an ultimate tensile strength of (typically) above 1500 MPa. A suitable test for measuring the ultimate tensile strength of the fibre is ASTM D3822.

Typical high strength fibres include carbon fibres or high tensile strength polymeric fibres, with suitable high tensile strength polymeric fibres including polyethylene (particularly UHMWPE), polyaramid, polybenzoxazole, and polyaromatic esters.

Suitable high strength fibres that can be used in the reinforcing fabric therefore include carbon fibre, UHMWPE fibres such as Dyneema® available from DSM or Spectra® available from Honeywell; polyaramid fibres such as Kevlar® available from DuPont; polybenzoxazole fibres such as Zylon® available from Toyobo; and polyaromatic esters such as Vectran® available from Kuararay, Inc. In the specific context it is however important that the selected reinforcing fabric is matched to the desired breathability. Water proof reinforcing fabrics are therefore not suitable in relation to the present invention unless such fabrics are treated prior to lamination, e.g. mechanically, to obtained the desired transmission of water vapor through the fabric.

In this context, UHMWPE is “ultra-high molecular weight polyethylene”, which is sometimes also referred to as high-modulus polyethylene (HMPE) or high-performance polyethylene (HPPE). UHMWPE is typically characterized by having an intrinsic velocity of at least 4 dl/g, desirably at least 8 dl/g. Generally, the intrinsic viscosity is less than 50 dl/g, typically less than 40 dl/g.

A suitable methodology for measuring intrinsic viscosity is ASTM D1601-2004 (at 135° C. in decalin, dissolution time 16 hours, with DBPC as an anti-oxidant in an amount of 2 g/l solution, by extrapolating the viscosity as measured at different concentrations to zero concentration).

The at least one layer in the reinforcing fabric comprising the high strength fibres may be woven or nonwoven. However, in order to benefit from the strength properties of the fibres, typically the at least one layer will contain the high strength fibres in an oriented fashion, such as woven (including uniweave), monodirectional or multidirectional fabrics.

Typically, the reinforcing fabric will comprise at least one layer having parallel high strength fibres. Said parallel high strength fibres may optionally be embedded in a resin matrix.

By “monodirectional fabrics” and “multidirectional fabrics” is meant fabrics formed with layers of oriented fibres embedded in a resin matrix, with multidirectional fabrics typically containing several layers of oriented fibres arranged orthogonally to one another (e.g. oriented at 0° and 90°, or at 0°, 45°, 90° and 135°), with optionally each layer being bound together by resin, or all the oriented layers being embedded in a continuous resin matrix.

The reinforcing fabric may be a multilayer composite which contains further layers in addition to the layers comprising the high strength fibres. For instance, nonwoven fabrics may be included on one or both sides of reinforcing fabric, in addition to the at least one layer comprising the high strength fibres. This can improve the feel of the reinforcing fabric.

The reinforcing fabric may also possess different properties with respect to water vapor permeability and should be chosen to match the desired properties of the footwear.

The level of adhesive penetration is thought to be significant as, once dried, the adhesive works in combination with the reinforcing fabric effectively fixing the first side of the piece of leather. If the adhesive penetration is through the entire leather sample, then the adhesive may prevent the leather expanding due to the water and hence prevent the surface texture developing. This is particularly the case when the piece of leather is very thin.

As a consequence, the penetration of the adhesive into the piece of leather is typically less than 50%, desirably less than 25%.

By “penetration” is meant how far the adhesive soaks through the piece of leather as a percentage of the distance from the first side (where the adhesive is applied) to the second side.

Further processing steps may be carried out following dry milling, for instance resizing (e.g. cutting into blanks ready for assembly into an article), and forming a multicomponent article comprising the leather laminate (for instance a shoe, bag, luggage, clothing, furniture, car trim or the like).

The present disclosure also relates to a leather laminate formed by the method described herein.

The present disclosure also relates to a leather laminate comprising a reinforcing fabric bonded to a leather layer which has undergone exposure to water and dry milling, said reinforcing fabric comprising high strength fibres, particularly which has undergone step iii′ or step iii″ of the method described herein.

Typically, the leather laminate of the disclosure comprises a reinforcing fabric bonded to a leather layer with an adhesive.

The leather laminate of the disclosure is characterised by a random (or non-repetitive) pebbled grain-like structure on the leather surface. Preferably, the reinforcing layer of the laminate also has a random (or non-repetitive) pebbled grain-like structure.

The structure may also be described as a shrunken, grain-like structure.

Typically, the pebbled grain-like structure is reduced when the laminate is stretched, for instance during bending.

By “grain-like structure” or “pebbled grain-like structure” is meant a surface structure made up of a continuous 2-D network of low features (cracks) that surround raised features (grains), wherein the distance between the grains (i.e. the distance across the cracks) is small compared to the distance across the grains (typically the distance across the grains is at least three times the width of the cracks, for example when 10 grain and crack pairs are measured). In this way, when viewed from above the cracks (i.e. the low points in the surface structure) are similar to grain boundaries and the grains (i.e. the raised features) are similar to grains in a sample of metal.

This type of surface texture on leather is typically called pebbled leather in the art.

The milling process used to form the laminate of the disclosure provides a combination of mechanical working as well as swelling caused by the water, which means the grains formed on the surface are uniquely shaped and typically have a low aspect ratio, such as below 5, more typically below 3 or even below 2.

By “uniquely shaped” is meant that each of the grain structures has a shape which is usually different from the other grains that surround it, with any similarity between two grains in the surface as a whole being a coincidence which does not give rise to a discernible repeating pattern.

By “aspect ratio” is meant the ratio of the largest dimension of the grain to the smallest dimension, when measured from above. When measuring the aspect ratio, typically 10 grains are chosen from the sample.

The size of the grains (i.e. both the width and vertical height) can be controlled by a number of factors, including the thickness and type of leather used, and the milling conditions.

Nevertheless, by way of guidance, the grain size is typically from 0.5 to 5 mm, more desirably from 0.5 to 3 mm or even from 1 to 2 mm.

A suitable way to determine the grain size is by averaging the largest dimension of typically 10 grains chosen from the sample.

The grain height is typically from 100 to 500 microns, more typically from 200 to 400 microns.

By “random” (or “non-repeating”) is meant that the pebbled grain-like structure does not repeat over any part of the surface of the leather layer, such that any two 1 cm2 sample areas taken from different parts of the surface are not the same.

It is worth noting that the grain-like structure of the leather surface and the grain-like structure of the reinforcing layer are not necessarily the same. They may have different grain sizes and/or grain heights, as well as different grain morphologies.

By “reduced during bending” is meant that the following relationship is satisfied:
ΔH≥75% when bending to a bend radius of R, wherein
R=5*t when t>1 mm, and
R=5 mm, when t≤1 mm,
t is the thickness in mm of the combined reinforcing layer and leather layer in the laminate (as measured by ASTM D1814-70(2015)), and

ΔH=100*(1−((H_initial−H_final)/H_initial)
Hinitial is the vertical difference between the high points of the grains and low points of the cracks separating grains when the laminate is flat, and
Hfinal is the vertical difference between the high points of the grains and low points of the cracks separating grains when the laminate is bent with a bend radius of R.

As noted, t is the thickness in mm of the combined reinforcing layer and leather layer in the laminate. In practice, it is the leather layer that is important. However, this cannot easily be separated from the reinforcing layer without risk of damage to the leather. Therefore, for the purposes of this test, the thickness of the laminate including the reinforcing layer is taken. In practice, the reinforcing layer is typically very thin in comparison to the leather layer, so the difference in thickness between the overall laminate and leather layer is often barely measurable using the SATRA test. However, any backing layers connected to the reinforcing layer (such as foam layers or other support layers) should be disregarded.

Hinitial and Hfinal represent the depth of the grain structure in the surface of the leather when the laminate is flat and when bent to a bend radius R. The value ΔH therefore represents the change in texturing of the surface as the laminate is bent.

Preferably:
ΔH≥90%

More preferably:
ΔH≥95%

Being a natural material, leather itself is relatively stretchy. However, when bonded to the high strength fabric after step ii, the laminate effectively loses its stretchiness compared to natural leather.

Thus, the non-bonded leather layer typically has an elongation at break of at least 10% without tearing, typically even more for instance at least 15%.

In the laminate prior to dry milling, the leather is restricted by the high strength fabric, and will typically have an elongation at break of less than 5%, more typically less than 4%, or even less than 3%.

The pebbled grain-like structure is primarily formed from the reduction in size of the laminate during dry milling. This dimensional change manifests causes the high strength fabric to crinkle up, meaning that after step iii, the laminate will typically have an elongation at break of by at least 5%, more typically at least 6%, or at least 7% or even at least 8%.

Stretching the laminate in this way will of course reduce the surface texture, as in part the grains arise due to the crinkling that occurs during the contraction that happens when dry milling. This is in contrast to artificially embossed leathers, which often retain their surface structure even when stretched or bent. The resultant surface texture of the leather of the disclosure therefore has a very natural appearance when formed into shaped articles and during use.

Thus, viewed in one way the leather laminate of the disclosure comprises a reinforcing fabric bonded to a leather layer, said reinforcing fabric comprising high strength fibres, wherein the surface of the leather layer and the surface of the reinforcing fabric each have a non-uniform, pebbled grain-like structure.

The leather laminate of the disclosure may also be viewed as comprising a reinforcing fabric bonded to a leather layer, said reinforcing fabric comprising high strength fibres and having an elongation at break (i.e. the elongation at break of the reinforcing layer alone) of less than 5% (or less than 4% or even less than 3%), wherein the leather laminate has an elongation at break of more than 5% (or more than 6 or more than 7% or even more than 8%).

Typically, one would expect the elongation at break of a multicomponent laminate to be equal to the elongation at break of the least elongatable layer. However, the elongation of break of the leather laminate is higher than the reinforcing fabric because the laminate has been shrunk to create the pebbled, grain-like structure.

Desirably, the leather layer in the laminate is thin, with the overall laminate typically having a thickness in line with the thicknesses of the leather layer set out in Step i. above, namely typically from 0.1 to 4 mm thick, or from 0.2 to 3.2 mm thick, or from 0.3 to 2 mm thick, or from 0.3 to 1.6 mm, or from 0.3 to 1.2 mm, or even from 0.3 to 0.8 mm.

The thickness of leather laminate can be calculated using SATRA TM 1:2004.

Desirably, the leather layer in the leather laminate of the disclosure derives from top grain leather.

Desirably, the leather layer in the leather laminate derives from nubuck leather.

Desirably, the nubuck leather has a velvet-like surface.

Desirably, the flesh side of the leather is bonded to the reinforcing layer in the leather laminate of the disclosure. In this way, the skin side of the laminate has the grain-like surface texture.

The present disclosure also relates to a personal item comprising, or made from, the leather laminate disclosed herein. In particular, the personal item may be footwear, an item of clothing, or a container.

Preferably, the disclosure relates to footwear comprising, or made from, the leather laminate disclosed herein.

Suitable footwear that could comprise, or be made from, the leather laminate includes work boots, sport shoes, casual shoes or formal shoes. The present leather laminate according to the provisions of the invention may however also be applied in several other appliances, such as clothing, sportswear, sport shoes, bags, accessories, car seat lining/leather seats, furniture, etc.

Leather is a unique material that has the ability to absorb water vapor, transmit through its cross section and permeate into the atmosphere. Thus, this unique characteristic of leather offers comfort to the wearer of clothing, shoes, etc. made on the basis of the leather laminate according to the provisions of the invention also in hot and humid conditions. In addition, upper leathers should possess comfort properties, strength properties, functional properties and aesthetic properties.

Adhesive may be used interchangeably with glue and is any substance applied to one surface, or both surfaces, of two separate items that binds them together and resists their separation.

The adhesive can in principle be any adhesive capable of bonding leather. Suitable adhesives may be adhesives such as hot melt polyamide adhesives. The hot melt polyamides may be non-volatile, thermoplastic adhesive resins such as Bostiks's Featured Hot Melt Polyamide Adhesives and examples hereof may be types such as HM4229, HM4289, and HM4278.

Adhesives may be used in combination with a hardener.

The adhesives can be applied in any suitable ways in order to make an adhesive pattern. The adhesive pattern may be applied by spraying, brushing, rollers, nozzles, as a film/web or any other suitable methods to apply adhesives with an adhesive pattern.

The term “breathability” refers to the capability of a material to allow liquid water (perspiration) to transport away from the skin to the outside, thus allowing comprehensive comport to the wearer. Breathability may therefore be defined as the ability of a fabric or material to allow the diffusion of moisture vapor transmission in order to promote evaporative cooling

Breathability and water vapor permeability are used interchangeably and may be evaluated by suitable methods for determining water vapor permeability of leather (ISO 14268) in mg/cm2/h. Standard methods such as ISO 14268 may be used to test water vapor permeability and accordingly the measurement may be of a test piece fixed over the opening of ajar, which contains solid desiccant. This unit may then be placed in a strong current of air in a conditioned atmosphere (23/50). To determine the mass of the moisture passing through the test piece and absorbed by the desiccant the jar is weighted and water vapor permeability can be calculated. In the present context the water vapor permeability is measured according to SATRA TM 172 unless otherwise stated.

The property of breathability depends upon a number of factors including porosity, thickness of leather, grease content and the relative humidity and temperature of the atmosphere. It is greatly reduced by the presence of the natural glyceride greases.

It should be noted that lamination in the present context is broadly understood as the technique of manufacturing a material in multiple layers, so that the composite material achieves improved strength, stability, appearance or other properties from the use of differing materials. A laminate is a permanently assembled object by heat, pressure, welding, or adhesives.

Tanning is used as the conventional ways of treating leather and may be applied to the invention. Depending on the compounds, the color and texture of the fabric may change. The technical definition of tanning is well known in the art, but briefly, according to Anthony D. Covington “Tanning Chemistry” chapter 10, the only strict definition of tanning is the conversion of a putrescible organic material into a stable material capable of resisting biochemical attack. Tanning involves a number of steps and reactions depending on the initial material and the final product.

In the case of collagen, it is the sidechains that largely define its reactivity and its ability to be modified by the stabilizing reactions of tanning when leather is made. In addition, the chemistry of the backbone, defined by the peptide links, offers different reaction sites that can be exploited in some tanning processes. During the tanning process, modification of collagen by the chemistry of the tanning agent(s) affects the different features of the properties of the material; The hydrophilic-hydrophobic balance of the leather may be markedly affected by the chemistry of the tanning agent by changing the relationship between the leather and the solvent, which in turn could affect the equilibrium of any reagent between the solvent and the substrate. Also, the site of reaction between the reagent and the collagen may affect the isoelectric point of the collagen and consequently there could be a different relationship between pH and charge on the leather. The lower the isoelectric point, the more anionic or less cationic the charge on the pelt may be at any pH value: the higher the isoelectric point, the more cationic or less anionic the charge on the pelt will be at any pH value. Further, the relative reactions at the sidechains and the backbone of the protein could possible determine the type of reaction and hence the degree of stability of the tannage: the fastness of the reagent may be influenced by the interaction between reagents and the substrate.

Hydrothermal stability as used herein could possibly be measured through the shrinkage temperature (Ts) of a hide. This is the temperature at which the energy input (heat) exceeds the energy bound in existing hydrogen bonding of the collagen structure resulting in the decomposition of the helical structure. The shrinkage temperature for untanned hides is generally around 65 degrees Celsius. The Ts may be increased through the process of tanning.

Chromium(III) sulfate ([Cr(H2O)6]2(SO4)3) has long been regarded as the most efficient and effective tanning agent. Chromium(III) compounds of the sort used in tanning are significantly less toxic than hexavalent chromium. Chromium(III) sulfate dissolves to give the hexaaquachromium(III) cation, [Cr(H2O)6]3+, which at higher pH undergoes processes called olation to give polychromium(III) compounds that are active in tanning being the cross-linking of the collagen subunits. The chemistry of [Cr(H2O)6]3+ is more complex in the tanning bath rather than in water due to the presence of a variety of ligands. Some ligands include the sulfate anion, the collagen's carboxyl groups, amine groups from the side chains of the amino acids, and masking agents. Masking agents are carboxylic acids, such as acetic acid, used to suppress formation of polychromium(III) chains. Masking agents allow the tanner to further increase the pH to increase collagen's reactivity without inhibiting the penetration of the chromium(III) complexes.

Collagen is characterized by a high content of glycine, proline, and hydroxyproline, usually in the repeat -gly-pro-hypro-gly. These residues give rise to collagen's helical structure. Collagen's high content of hydroxyproline allows for significant cross-linking by hydrogen bonding within the helical structure. Ionized carboxyl groups (RCO2-) are formed by hydrolysis of the collagen by the action of hydroxide. This conversion occurs during the liming process, before introduction of the tanning agent (chromium salts). The ionized carboxyl groups coordinate as ligands to the chromium(III) centers of the oxo-hydroxide clusters.

Tanning increases the spacing between protein chains in collagen from 10 to 17 Å. The difference is consistent with cross-linking by polychromium species, of the sort arising from olation and oxolation.

One way of performing a tanning is explained in the following. Prior to the introduction of the basic chromium species in tanning, several steps are required to produce a tannable hide. The pH must be very acidic when the chromium is introduced to ensure that the chromium complexes are small enough to fit in between the fibers and residues of the collagen. Once the desired level of penetration of chrome into the substance is achieved, the pH of the material is raised again to facilitate the process. This step is known as basification. In the raw state, chrome-tanned skins are greyish-blue, so are referred to as wet blue. Chrome tanning is faster than vegetable tanning (less than a day for this part of the process) and produces a stretchable leather which is excellent for use in handbags and garments.

Subsequent to application of the chromium agent, the bath is treated with sodium bicarbonate to increase the pH to 4.0-4.3, which induces cross-linking between the chromium and the collagen. The pH increase is normally accompanied by a gradual temperature increase up to 40° C. Chromium's ability to form such stable bridged bonds explains why it is considered one of the most efficient tanning compounds. This efficiency is characterized by its increased hydrothermal stability of the skin, and its resistance to shrinkage in heated water.

The leather of the leather laminate may typically comprise tanning agents in the amount of 3 to 12% by weight of the leather when the tanning agents includes chrome tanning agents.

The chrome tanning agents includes chromium, chromium salts and/or derivatives thereof.

The leather of the leather laminate may as a further restriction in relation to the total content of tanning agent in the leather comprise chrome tanning agent(s) in the amount of 1 to 7% by weight of the leather, such as 2 to 6% by weight of the leather such as 2 to 5% by weight of the leather.

The specific content of chrome tanning in the amount of 1 to 7% by weight of the leather, such as 2 to 5% by weight of the leather is in particular attractive in relation to the inventive leather laminate as this content of chrome in the leather of the laminate makes is possible to use heat-activated adhesive to attach the leather to the reinforcing fabric. It is moreover, and even more advantageous in applications where the leather as to be steamed e.g. for purposes of shaping etc.

The chrome tanning agents includes chromium, chromium salts and/or derivatives thereof.

FIG. 1A illustrates an exploded view of the leather laminate 100 of FIG. 1B showing the leather layer 11, an adhesive 10 and the reinforcing fabric 13.

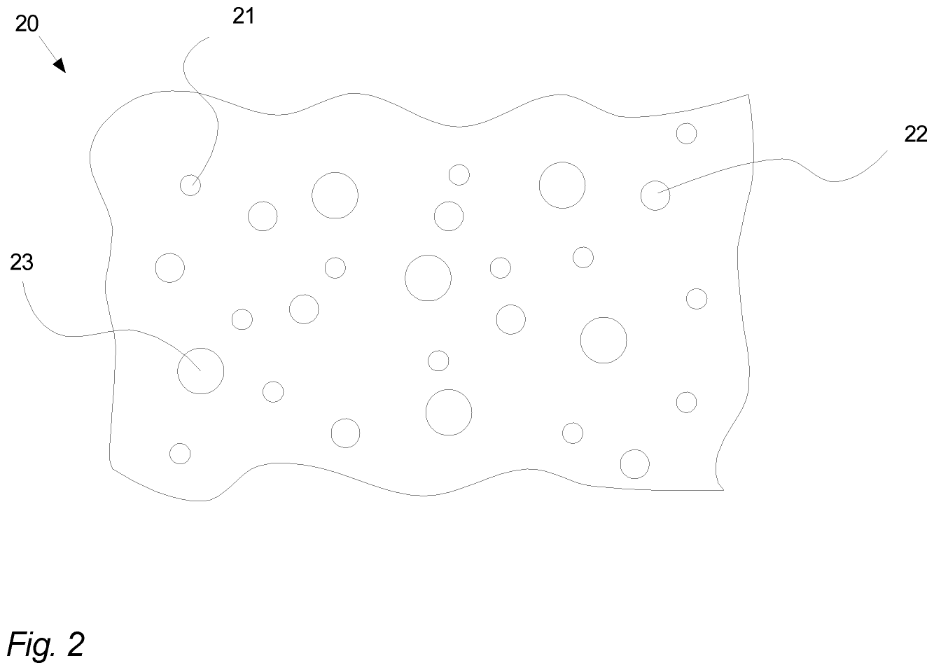

FIG. 2 illustrates a possible configuration of adhesive 20 having water vapor passages 21 and 22. Such a configuration is of course illustrative, but different patterns of adhesion may be applied within the scope of the invention. The patterns may be obtained in different ways, e.g. by spraying by controlled nozzles, small areas where adhesion in not intended may be defined by adhesive repellant material prior to lamination, mesh or a web may be used, adhesive may be subjected in the form of foam, etc., thereby providing whatever pattern of water vapor passages desired.

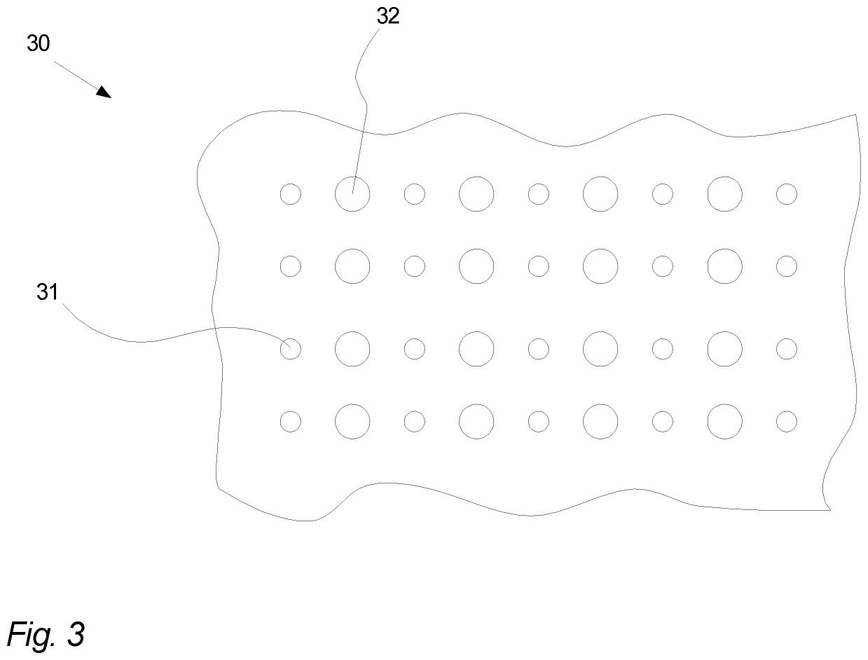

FIG. 3 illustrates a further possible configuration of adhesive 30 having water vapor passages 31 and 32.

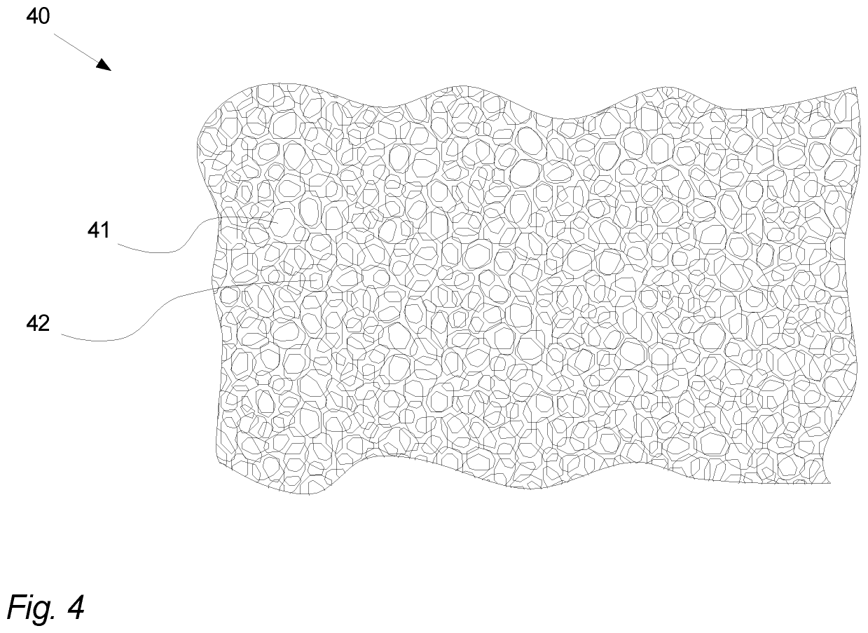

FIG. 4 illustrates a further possible configuration of adhesive 40 having water vapor passages 41 and 42.

Other configurations of the adhesive with respect water vapor passages may of course applied within the scope of the invention. Some configurations may be more mesh-like, honeycomb or other patterns as long as the obtained water permeability and laminate strength is satisfactory for the desired purpose.

1. A leather laminate composite comprising a leather layer and reinforcing fabric laminated together via an adhesive,
wherein the adhesive comprises water vapor passages.

2. The leather laminate according to claim 1, wherein the leather laminate has a water vapor permeability of above 5 mg/cm2/hour.

3. The leather laminate according to claim 1, wherein the leather laminate has a water vapor permeability of above 5 mg/cm2/hour.

4. The leather laminate according to claim 1, wherein a variation of breathability of a leather laminate varies with less than 25% measured over a plurality of leather laminates.

5. The leather laminate according to claim 1, wherein a thickness of the reinforcing fabric is below 0.1 mm.

6. The leather laminate according to claim 1, wherein an ultimate tensile strength of the reinforcing fabric is at least above 5 kN/m.

7. (canceled)

8. The leather laminate according to claim 1, wherein an elongation at break of the reinforcing fabric is between 0.2% and 10%.

9. The leather laminate according to claim 1, wherein a tear strength of the reinforcing fabric is at least 25 N.

10. (canceled)

11. The leather laminate according to claim 1, wherein a tensile strength of the reinforcing fabric is between 1 GPa and 5 GPa.

12. (canceled)

13. The leather laminate according to claim 1, wherein a peel strength of the leather laminate is between 0.3 N/mm and 1.5 N/mm.

14. The leather laminate according to claim 1, wherein the reinforcing fabric, the adhesive, and the leather are compatible.

15.-16. (canceled)

17. The leather laminate according to claim 1, wherein the leather layer is obtained from top grain leather.

18. The leather laminate according to claim 1, wherein a flesh-side of the leather layer is facing the reinforcing fabric of the leather laminate composite.

19. The leather laminate according to claim 1, wherein the leather layer is tanned and extends in a X and Y direction.

20. The leather laminate according to claim 1, wherein the leather laminate has a thickness of 0.4 to 1.0 mm.

21. The leather laminate according to claim 1, wherein the leather laminate has a thickness ranging between 0.6 to 1.2 mm, or greater than 1.2 mm.

22. The leather laminate according to claim 1, wherein the leather laminate has a thickness ranging between 1.2 to 2 mm, or greater than 2 mm.

23. The leather laminate according to claim 1, wherein the leather laminate has a thickness ranging between 2.0 to 3 mm, or greater than 3 mm.

24. (canceled)

25. The leather laminate according to claim 1, wherein the leather layer of the leather laminate is originating from a cow hide and wherein the leather layer is tanned.

26. The leather laminate according to claim 1, wherein the leather layer of the leather laminate comprises tanning agents in the amount of 3 to 15% by weight of the leather layer.

27.-33. (canceled)
